(19) United States
(12) Patent Application Publication
(10) Pub. No.: US 2008/0173080 A1
(43) Pub. Date: Jul. 24, 2008

(54) NASCAR BODY DIMENSION OR CONFIGURATION MEASURING DEVICE

(76) Inventor: John W. Strauser, Kennewick, WA (US)

Correspondence Address: Floyd E. Ivey;Liebler, Ivey, Connor & Berry, P.O. Box 6125, Kennewick, WA, 99336, US

(21) Appl. No.: 11/487,926

(22) Filed: Jul. 17, 2006

(51) Int. Cl. G01M 17/00

(52) U.S. Cl. 73/117.01

(57) ABSTRACT

The Measuring Device (1) disclosed and claimed comprises a Frame (10) pivotally supporting an Extender component (20) having an Extender contact (32). The Frame (10) additionally pivotally supports a Stabilizer (40) which is pivotally interconnected to the Extender component (20) and to the Frame (10). The Frame (10) has a Frame cover (90) with a Retainer (92). The Extender component (20) is spring biased by Spring (70). The Extender component (20) is retained in a closed position when a Retainer (92) is extended from within the Frame cover (90) to secure the Extender component (20) from upward movement. Spring (70) causes the Extender component (20) to be urged upwardly when the Retainer (92) is retracted into the Frame cover (90). A Sliding contact rod (64), moving a potentiometer contact within a Potentiometer (60), is moved proportional to movement of the Extender component (20). A Cable (80) with at least one Conductor (82) provides a voltage output from the potentiometer (60) to an electronic circuit or meter which can be calibrated to indicate the distance from a surface to a frame member of an automobile.

### FIELD OF THE INVENTION

This invention relates to an apparatus for measuring tolerances, on NASCAR and other racing cars, from a known surface to a specific portion of the body, frame or other part of the vehicle.

### BACKGROUND OF THE INVENTION

NASCAR and other racing cars abide by tolerances established by the appropriate authority. Measurements are made from a flat surface, generally a metal plate, to the particular frame or other member.

### SUMMARY OF THE INVENTION

The Measuring Device (1) disclosed and claimed comprises a Frame (10) pivotally supporting an Extender component (20) having an Extender contact (32). The Frame (10) additionally pivotally supports a Stabilizer (40) which is pivotally interconnected to the Extender component (20) and to the Frame (10). The Frame (10) has a Frame cover (90) with a Retainer (92). The Extender component (20) is spring biased by Spring (70). The Extender component (20) is retained in a closed position when a Retainer (92) is extended from within the Frame cover (90) to secure the Extender component (20) from upward movement. Spring (70) causes the Extender component (20) to be urged upwardly when the Retainer (92) is retracted into the Frame cover (90). A Sliding contact rod (64), moving a potentiometer contact within a Potentiometer (60), is moved proportional to movement of the Extender component (20). A Cable (80) with at least one Conductor (82) provides a variable voltage output to an electronic circuit or meter which can be calibrated to indicate the distance from a surface to a frame member of an automobile.

### BRIEF DESCRIPTION OF THE DRAWINGS

The foregoing and other features and advantages of the present invention will become more readily appreciated as the same become better understood by reference to the following detailed description of the preferred embodiment of the invention when taken in conjunction with the accompanying drawings, wherein:

FIG. 1 is a perspective of the Measuring device (1) showing the Frame (10) having a Frame first end (12), a Frame second end (14), a Frame bottom (16). Seen is an Extender component (20) with an Extender guide rod (22), an Extender guide rod first locator (24), an extender guide rod intermediate locator (25) and an Extender guide rod second locator (26). Also illustrated is an Extender pivot and attachment plate (28), Extender frame (30), Extender contact (32), Extender pivot (34), Extender first end (35), Extender second end (36). Seen is a Stabilizer (40) having a Stabilizer frame (42), Stabilizer pivot (44), Stabilizer pivot plate (46). Illustrated is a Spring holder (50). Also seen is a Potentiometer (60) with a Sliding contact rod (64). Seen is the Extender Spring (70) and Cable (80) and Conductors (82).

FIG. 2 is a top plan of the Measuring device (1) with the Extender component (20) recessed into the Frame (10).

FIG. 3 is a top plan of the Measuring device (1) with the Extender component (20) raised.

FIGS. 4 and 5 show details of the Stabilizer (40) illustrating the Stabilizer frame (42), Spring holder (50) and Spring (52).

FIG. 6 is a section from FIG. 5 illustrating the Stabilizer frame (42), Spring holder (50) and Spring (52).

FIG. 7 is a top plan of a Frame cover (90) showing a Retainer (92) and retainer slot or bracket (94).

FIG. 8 is a section from FIG. 7 illustrating the Retainer (92).

FIG. 9 illustrates an alternative form of the extender pivot and attachment plate (28) showing the extender pivot and attachment plate first end (28′) and the extender pivot and attachment plate second end (28″) in bearing and guide contact with the frame first side (17) and frame second side (18) respectfully.

### DETAILED DESCRIPTION

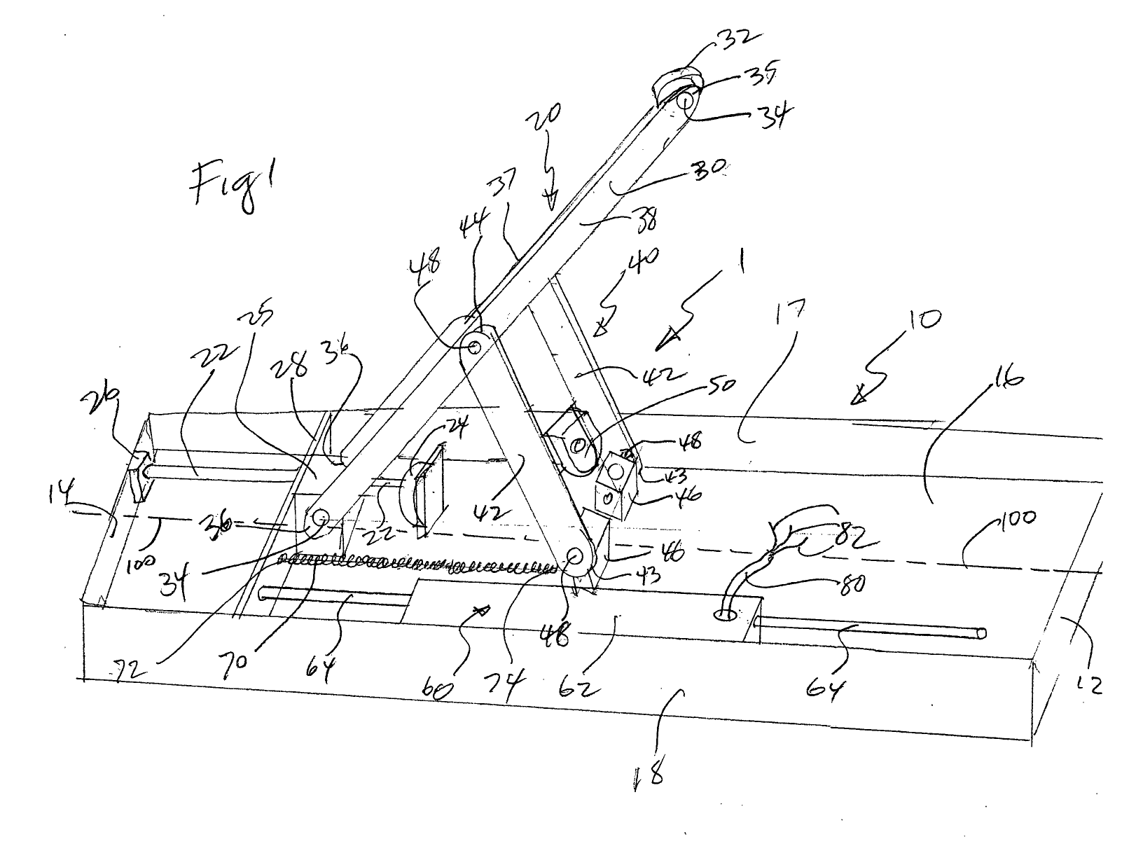

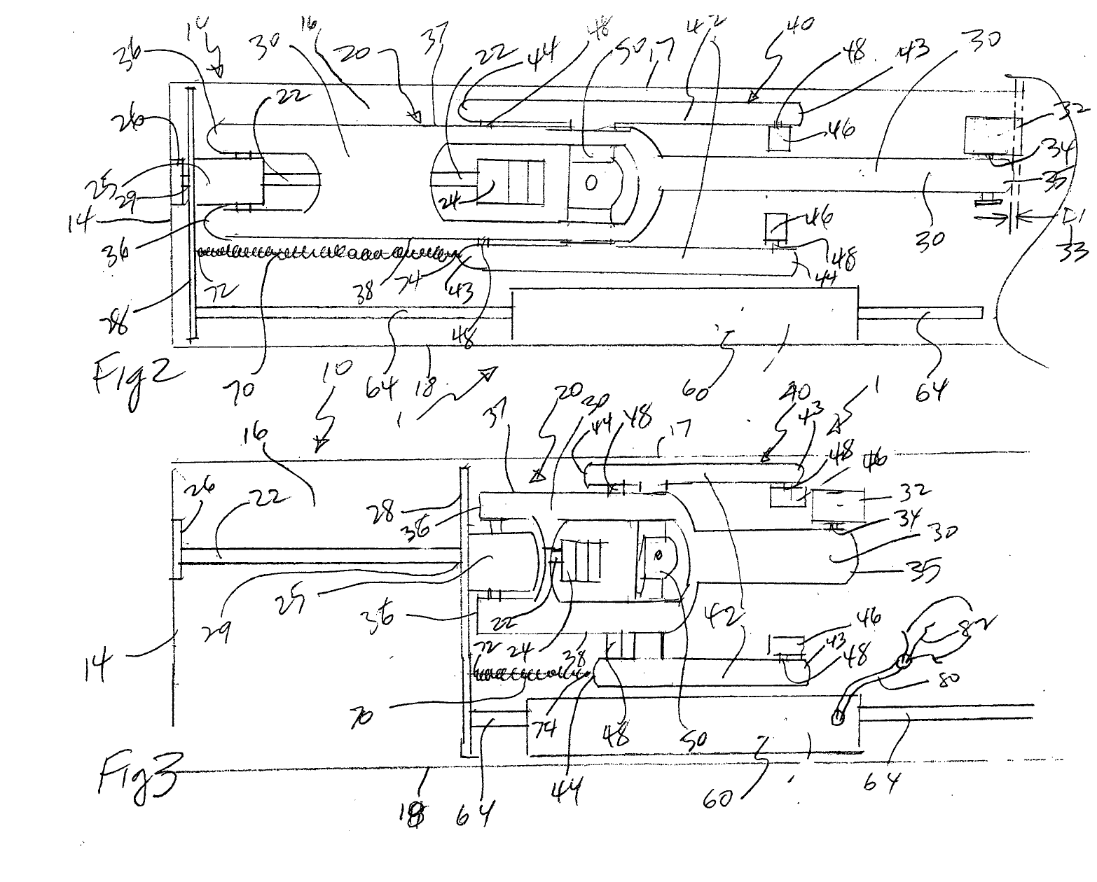

FIGS. 1, 2 and 3 illustrate the Measuring device (1) and showing a Frame (10) having a Frame first end (12), a Frame second end (14) and a Frame bottom (16); a Frame axis (100) centrally positioned from the Frame first end (12) to the Frame second end (14). Also illustrated is an Extender component (20) which has an Extender frame (30) having an Extender first end (35), an Extender second end (36), an extender first side (37) and an extender second side (38); the Extender frame (30), proximal the Extender second end (36), is pivotally interconnected by extender pivot (34) means with an Extender pivot and attachment plate (28). The extender component (20) is parallel with the frame bottom (16) when the extender component (20) is recessed; the extender component (20) pivotally extends upwardly from the frame bottom (16) when raised.

Also seen is the Extender pivot and attachment plate (28) having guide means which receives an Extender guide rod (22), the Extender guide rod (22) is immovably fixed by guide rod immovable affixing means, proximal the Frame second end (14), at an Extender guide rod first locator (24). The Extender guide rod (22) is immovably fixed by guide rod immovable affixing means, distal the Frame second end (14), at an Extender guide rod second locator (26); the Extender pivot and attachment plate (28) is intermediate the Extender guide rod first locator (24) and the Extender guide rod second locator (26).

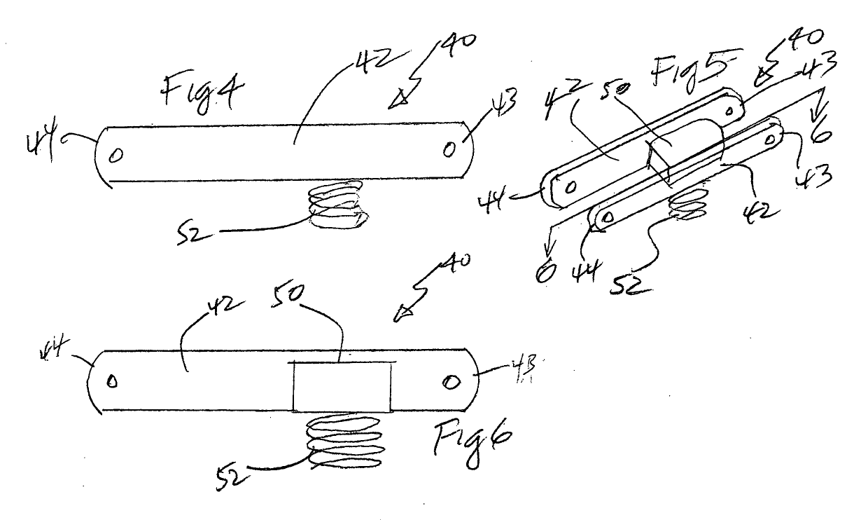

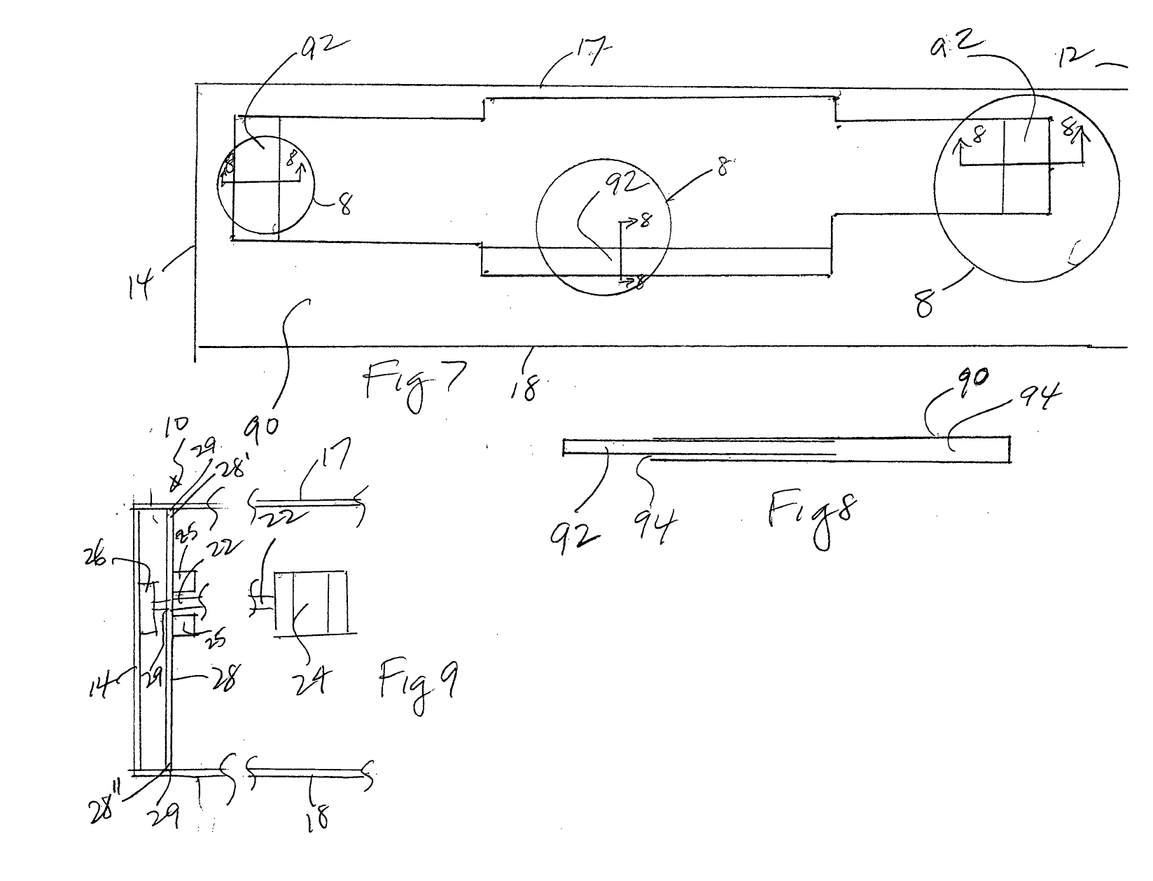

Illustrated in FIGS. 1, 2, 3 and 4 is an Extender contact (32) proximal the Extender first end (35) and an at least one stabilizer (40) having an at least one stabilizer frame (42); the at least one stabilizer frame (42) having a stabilizer frame first end (43) and a stabilizer frame second end (44); stabilizer pivot means (48) rotatably interconnecting the stabilizer frame first end (43) with a stabilizer pivot plate (46); the stabilizer pivot plate (46) upstanding and rigidly affixed by plate affixing means to the frame bottom (16); stabilizer pivot means (48) rotatably interconnecting the stabilizer frame second end (44) with the extender frame (30) at the extender first side (37) or the extender second side (38).

Shown is spring affixing means formed by a Spring holder (50); the spring holder comprised of a cylinder fixedly receiving the stabilizer spring (52) or other mechanical interconnections including clip, bracket and other spring attaching means known to those of ordinary skill in the spring arts rigidly affixed to the at least one stabilizer (40) intermediate the stabilizer frame first end (43) and the stabilizer frame second end (44); the spring holder (50) extending from the at least one stabilizer (40) orthogonal to the frame axis (100); stabilizer spring (52) received by spring affixing means at the spring holder (50) and extending downwardly toward the frame bottom (16) when the extender component (20) is recessed; the stabilizer spring (52) is compressed when the extender component (20) is recessed and urges the extender component (20) upwardly from the frame bottom (16); retraction means (70), having retraction means first end (72) and retraction means second end (74); the retraction means (70) affixed by retraction affixing means at the retraction means first end (72) to the extender pivot and attachment plate (28) and affixed by retraction affixing means at the retraction means second end (74) to a stabilizer pivot (46); the retraction means (70) urging by a spring function the extender component (20) upwardly and away from the frame bottom (16).

Seen is a variable resistance means (60) affixed by variable resistance affixing means within the frame and, in the preferred embodiment, at or proximal the frame bottom (16); the variable resistance means (60) interconnected by potentiometer movement interconnection means (64) with the extender pivot and attachment plate (28); the potentiometer movement interconnection means (60) is movably interconnected with the variable resistance means (60); electrical communication power means (80) to apply voltage across the variable resistance means (60); electrical measurement means (82) to provide a measurement means to measure change in voltage from the output of the variable resistance means (60) with movement of the potentiometer movement interconnection means (64). Electrical communication power means (80) is, in the preferred embodiment, cable and wiring means communicating a voltage to a potentiometer. Power may be provided by external or internal power supply. The electrical measurement means (82) may be by cable and wiring or wireless to a detector means such as a digital voltmeter or a computer input to cause a program to receive and display a conversion from voltage to distance.

FIGS. 7 and 8 illustrate a frame cover (90) generally parallel with the frame bottom (16); an aperture in the frame cover (90) permitting passage of the extension component (20) for the extension and recession of the extension component (20); a retainer (92) movably interconnected with the frame cover (90); the retainer (92) extendable to prevent extension of the extension component (20) and retractable to allow extension of the extension component (20); the retainer (92) slidably received by a bracket or slot means (94) proximal the frame first end (12), frame second end (14), frame first side (17) or frame second side (18).

The frame (10) and extender component (20) formed of rigid materials including metals, composite materials, plastics; the frame (10) being generally of planar materials. The extender component (20) being elongated and generally formed of tubular or planar materials; the frame (10) and the extender component (20) being formed by press, molded or machined processes;

The extender pivot (34) means comprised of aperture or bearing means fixedly and rotatably receiving a rod, bearing or bushing interconnecting the extender frame (30) proximal the extender frame first end (35) and the extender contact (32); the extender contact being generally ball shaped or cylindrical and extending beyond the extender frame first end (35) for the purpose of contacting a frame or other NASCAR body component; the extender contact (32) extending beyond the extender frame first end (35) by a distance D1 (33).

The extender pivot and attachment plate (28) being generally planar and providing an anchor or affixing structure or plate to which is affixed the extender guide rod intermediate locator (25), retraction means (70) and potentiometer movement interconnection means (64).

The extender component (20) pivotally extends upwardly from the frame bottom (16) by the retraction means (70) provided by a spring (70) in tension when the extender component (20) is recessed; the spring (70) at the spring first end (72) affixed by spring affixing means at the extender pivot and attachment plate (28); spring affixing means including aperture receiving hook, eye hook with screw and other mechanical means; potentiometer movement interconnection means (64) includes aperture receiving rod with thread and bolt, eye hook with screw and other mechanical means.

The extender guide rod (22) being elongated and cylindrical provides stability in the movement of the extender component (20) when extended to measure a dimension of a NASCAR frame or other component; the Extender guide rod (22) is immovably fixed by guide rod immovable affixing means, proximal the Frame second end (14), and distal to the frame second end (14) by mechanical means including bolt and nut, screw and welding provided by the extender guide rod first locator (24), which is proximal to or in contact with or extending from the frame second end (14), and the extender guide rod second locator (26) which is distal to the frame second end (14); the extender guide rod second locator (26) upstanding from the frame bottom (16) formed by press, molding, machining or other means and rigidly affixed to the frame bottom (16); aperture and bearing means (29) in the extender pivot and attachment plate (28) receives the extender guide rod (22); the aperture and bearing means (29) comprised of an aperture (29) in the extender pivot and attachment plate (28) or by extender guide rod intermediate locator (25) comprising a cylinder extending from the extender pivot and attachment plate (28) toward the frame first end (12) and having an aperture (29) therein which receives the extender guide rod (22); the extender guide rod (22) received substantially parallel with the frame axis (100).

The at least one stabilizer frame (42) is elongate and generally planar or cylindrical providing stabilizing support for the extender component (20) when the extender component (20) is extended. In the preferred embodiment the at least one stabilizer frame (42) comprising at least two stabilizer frames (42) one each proximal the frame first side (17) and the frame second side (18) respectfully; stabilizer pivot means (48) comprised of aperture or bearing means fixedly and rotatably receiving a rod, bearing or bushing rotatably interconnecting the stabilizer frame first end (43) with a stabilizer pivot plate (46); the stabilizer pivot plate (46) upstanding and rigidly affixed by plate affixing means to the frame bottom (16); plate affixing means comprising machining, molding, forming, pressing, welding.

Spring affixing means formed by a Spring holder (50) rigidly affixed to the at least one stabilizer (40) intermediate the stabilizer frame first end (43) and the stabilizer frame second end (44); the spring holder (50) extending from the at least one stabilizer (40) orthogonal to the frame axis (100); stabilizer spring (52) received by spring affixing means at the spring holder (50) and extending downwardly toward the frame bottom (16) when the extender component (20) is recessed; the stabilizer spring (52) is compressed when the extender component (20) is recessed and urges the extender component (20) upwardly from the frame bottom (16); retraction means (70), having retraction means first end (72) and retraction means second end (74); the retraction means (70) affixed by retraction affixing means at the retraction means first end (72) to the extender pivot and attachment plate (28) and affixed by retraction affixing means at the retraction means second end (74) to a stabilizer pivot (46); the retraction means (70) urging by a spring function the extender component (20) upwardly and away from the frame bottom (16).

A variable resistance means (60) affixed by variable resistor affixing within the frame and, in the preferred embodiment, at or proximal the frame bottom (16); the variable resistance means (60) interconnected by potentiometer movement interconnection means (64) with the extender pivot and attachment plate (28); the potentiometer movement interconnection means (64) is movably interconnected with the variable resistance means (60); electrical communication power means (80) to apply voltage across the variable resistance means (60); electrical measurement means (82) to provide a measurement means to measure change in voltage output from the variable resistance means (60) with movement of the potentiometer movement interconnection means (64).

A frame cover (90) generally parallel with the frame bottom (16); an aperture in the frame cover (90) permitting passage of the extension component (20) for the extension and recession of the extension component (20); a retainer (92) movably interconnected with the frame cover (90); the retainer (92) extendable to prevent extension of the extension component (20) and retractable to allow extension of the extension component (20); the retainer (92) slidably received by a bracket or slot means (94) proximal the frame first end (12), frame second end (14), frame first side (17) or frame second side (18).

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

I claim:

1. A Measuring device (1) comprising:
a. a Frame (10) having a Frame first end (12), a Frame second end (14) and a Frame bottom (16); a Frame axis (100) centrally positioned from the Frame first end (12) to the Frame second end (14);
b. an Extender component (20) has an Extender frame (30) having an Extender first end (35), an Extender second end (36), an extender first side (37) and an extender second side (38); the Extender frame (30), proximal the Extender second end (36), is pivotally interconnected by extender pivot (34) means with an Extender pivot and attachment plate (28); the extender component (20) is parallel with the frame bottom (16) when the extender component (20) is recessed; the extender component (20) pivotally extends upwardly from the frame bottom (16) when raised;
c. the Extender pivot and attachment plate (28) having guide means which receives an Extender guide rod (22), the Extender guide rod (22) is immovably fixed by guide rod immovable affixing means, proximal the Frame second end (14), at an Extender guide rod first locator (24); the Extender guide rod (22) is immovably fixed by guide rod immovable affixing means, distal the Frame second end (14), at an Extender guide rod second locator (26); the Extender pivot and attachment plate (28) is intermediate the Extender guide rod first locator (24) and the Extender guide rod second locator (26);
d. an Extender contact (32) proximal the Extender first end (35);
e. an at least one stabilizer (40) having an at least one stabilizer frame (42); the at least one stabilizer frame (42) having a stabilizer frame first end (43) and a stabilizer frame second end (44); stabilizer pivot means (48) rotatably interconnecting the stabilizer frame first end (43) with a stabilizer pivot plate (46); the stabilizer pivot plate (46) upstanding and rigidly affixed by plate affixing means to the frame bottom (16); stabilizer pivot means (48) rotatably interconnecting the stabilizer frame second end (44) with the extender frame (30) at the extender first side (37) or the extender second side (38);
f. spring affixing means formed by a Spring holder (50); the spring holder comprised of a cylinder fixedly receiving the stabilizer spring (52) or other mechanical interconnections including clip, bracket and other spring attaching means rigidly affixed to the at least one stabilizer (40) intermediate the stabilizer frame first end (43) and the stabilizer frame second end (44); the spring holder (50) extending from the at least one stabilizer (40) orthogonal to the frame axis (100); stabilizer spring (52) received by spring affixing means at the spring holder (50) and extending downwardly toward the frame bottom (16) when the extender component (20) is recessed; the stabilizer spring (52) is compressed when the extender component (20) is recessed and urges the extender component (20) upwardly from the frame bottom (16); retraction means (70), having retraction means first end (72) and retraction means second end (74); the retraction means (70) affixed by retraction affixing means at the retraction means first end (72) to the extender pivot and attachment plate (28) and affixed by retraction affixing means at the retraction means second end (74) to a stabilizer pivot (46); the retraction means (70) urging by a spring function the extender component (20) upwardly and away from the frame bottom (16);
g. a variable resistance means (60) affixed by variable resistor affixing means at or within the frame or proximal the frame bottom (16); the variable resistance means (60) interconnected by potentiometer movement interconnection means (64) with the extender pivot and attachment plate (28); the potentiometer movement interconnection means (64) is movably interconnected with the variable resistance means (60); electrical communication power means (80) to apply voltage across the variable resistance means (60); electrical measurement means (82) to provide a measurement means to measure change in voltage output from the variable resistance means (60) with movement of the potentiometer movement interconnection means (64);
h. a frame cover (90) generally parallel with the frame bottom (16); an aperture in the frame cover (90) permitting passage of the extension component (20) for the extension and recession of the extension component (20); a retainer (92) movably interconnected with the frame cover (90); the retainer (92) extendable to prevent extension of the extension component (20) and retractable to allow extension of the extension component (20); the retainer (92) slidably received by a bracket or slot means (94) proximal the frame first end (12), frame second end (14), frame first side (17) or frame second side (18).

2. The Measuring device (1) of claim 1 further comprising:
a. the frame (10) and extender component (20) formed of rigid materials including metals, composite materials, plastics; the frame (10) being generally of planar materials; the extender component (20) being elongated and generally formed of tubular or planar materials; the frame (10) and the extender component (20) being formed by press, molded or machined processes;
b. extender pivot (34) means comprised of aperture or bearing means fixedly and rotatably receiving a rod, bearing or bushing interconnecting the extender frame (30) proximal the extender frame first end (35) and the extender contact (32); the extender contact being generally ball shaped or cylindrical and extending beyond the extender frame first end (35) for the purpose of contacting a frame or other NASCAR body component; the extender contact (32) extending beyond the extender frame first end (35) by a distance D1 (33);
c. the extender pivot and attachment plate (28) being generally planar and providing an anchor or affixing structure or plate to which is affixed the extender guide rod intermediate locator (25), retraction means (70) and potentiometer movement interconnection means (64);
d. the extender component (20) pivotally extends upwardly from the frame bottom (16) by the retraction means (70) provided by a spring (70) in tension when the extender component (20) is recessed; the spring (70) at the spring first end (72) affixed by spring affixing means at the extender pivot and attachment plate (28); spring affixing means including aperture receiving hook, eye hook with screw and other mechanical means; potentiometer movement interconnection means (64) includes aperture receiving rod with thread and bolt, eye hook with screw and other mechanical means;
e. the extender guide rod (22) being elongated and cylindrical provides stability in the movement of the extender component (20) when extended to measure a dimension of a NASCAR frame or other component; the Extender guide rod (22) is immovably fixed by guide rod immovable affixing means, proximal the Frame second end (14), and distal to the frame second end (14) by mechanical means including bolt and nut, screw and welding provided by the extender guide rod first locator (24), which is proximal to or in contact with or extending from the frame second end (14), and the extender guide rod second locator (26) which is distal to the frame second end (14); the extender guide rod second locator (26) upstanding from the frame bottom (16) formed by press, molding, machining or other means and rigidly affixed to the frame bottom (16); aperture and bearing means (29) in the extender pivot and attachment plate (28) receives the extender guide rod (22); the aperture and bearing means (29) comprised of an aperture (29) in the extender pivot and attachment plate (28) or by extender guide rod intermediate locator (25) comprising a cylinder extending from the extender pivot and attachment plate (28) toward the frame first end (12) and having an aperture (29) therein which receives the extender guide rod (22); the extender guide rod (22) received substantially parallel with the frame axis (100);
f. the at least one stabilizer frame (42) is elongate and generally planar or cylindrical providing stabilizing support for the extender component (20) when the extender component (20) is extended; the at least one stabilizer frame (42) comprising at least two stabilizer frames (42) one each proximal the frame first side (17) and the frame second side (18) respectfully; stabilizer pivot means (48) comprised of aperture or bearing means fixedly and rotatably receiving a rod, bearing or bushing rotatably interconnecting the stabilizer frame first end (43) with a stabilizer pivot plate (46); the stabilizer pivot plate (46) upstanding and rigidly affixed by plate affixing means to the frame bottom (16); plate affixing means comprising machining, molding, forming, pressing, welding;
g. spring affixing means formed by a Spring holder (50) rigidly affixed to the at least one stabilizer (40) intermediate the stabilizer frame first end (43) and the stabilizer frame second end (44); the spring holder (50) extending from the at least one stabilizer (40) orthogonal to the frame axis (100); stabilizer spring (52) received by spring affixing means at the spring holder (50) and extending downwardly toward the frame bottom (16) when the extender component (20) is recessed; the stabilizer spring (52) is compressed when the extender component (20) is recessed and urges the extender component (20) upwardly from the frame bottom (16); retraction means (70), having retraction means first end (72) and retraction means second end (74); the retraction means (70) affixed by retraction affixing means at the retraction means first end (72) to the extender pivot and attachment plate (28) and affixed by retraction affixing means at the retraction means second end (74) to a stabilizer pivot (46); the retraction means (70) urging by a spring function the extender component (20) upwardly and away from the frame bottom (16);
h. a variable resistance means (60) affixed by variable resistor affixing means at or in the frame or proximal the frame bottom (16); the variable resistance means (60) interconnected by potentiometer movement interconnection means (64) with the extender pivot and attachment plate (28); the potentiometer movement interconnection means (64) is movably interconnected with the variable resistance means (60); electrical communication power means (80) to apply voltage across the variable resistance means (60); electrical measurement means (82) to provide a measurement means to measure change in voltage output from the variable resistance means (60) with movement of the potentiometer movement interconnection means (64);
I. a frame cover (90) generally parallel with the frame bottom (16); an aperture in the frame cover (90) permitting passage of the extension component (20) for the extension and recession of the extension component (20); a retainer (92) movably interconnected with the frame cover (90); the retainer (92) extendable to prevent extension of the extension component (20) and retractable to allow extension of the extension component (20); the retainer (92) slidably received by a bracket or slot means (94) proximal the frame first end (12), frame second end (14), frame first side (17) or frame second side (18).

3. The Measuring device (1) of claim 2 further comprising:
a. the bearing pin received by aligned apertures in the Extender frame (30) and in the Extender pivot and attachment plate (28) are generally orthogonal to the axis (100);
b. the Extender guide rod (22) is composed of an elongated generally cylindrical shaft;
c. pivot means interconnecting the Extender pivot and attachment plate (28) and the Extender frame (30) comprised of at least one Extender pivot (34) comprised of a bearing pin received by aligned apertures;
d. guide means, which receives an Extender guide rod (22), include aperture and or slot in the Extender pivot and attachment plate (28) oriented to position the Extender guide rod (22) parallel with the axis (100);
e. guide rod affixing means, proximal the Frame second end (14) and distal to the Frame second end (14), composed threaded means, welding.

4. A Measuring device (1) comprising:
a. a Frame (10);
b. an Extender component (20) is pivotally interconnected with the Frame; the extender component (20) pivotally extends upwardly from the frame (10) when raised;
c. a variable resistance means (60) movably interconnected by potentiometer movement interconnection means (64) with the extender component (20); the potentiometer movement interconnection means (64) is movably interconnected with the variable resistance means (60); electrical power means (80) to apply voltage across the variable resistance means (60); electrical measurement means (82) to provide a measurement means to measure change in voltage output from variable resistance means (60) with movement of the potentiometer movement interconnection means (64).

5. A measuring device (1) from claim 4 further comprising:
a. the Frame (10) having a Frame first end (12), a Frame second end (14) and a Frame bottom (16); a Frame axis (100) centrally positioned from the Frame first end (12) to the Frame second end (14);
b. the Extender component (20) has an Extender frame (30) having an Extender first end (35), an Extender second end (36), an extender first side (37) and an extender second side (38); the Extender frame (30), proximal the Extender second end (36), is pivotally interconnected by extender pivot (34) means with an Extender pivot and attachment plate (28);
c. the Extender pivot and attachment plate (28) having Extender component (20) guide means;
d. an Extender contact (32) proximal the Extender first end (35);
e. a variable resistance means (60) affixed by variable resistor affixing means at or within the frame or proximal the frame bottom (16); the variable resistance means (60) interconnected by potentiometer movement interconnection means (64) with the extender pivot and attachment plate (28); the potentiometer movement interconnection means (64) is movably interconnected with the variable resistance means (60); electrical communication power means (80) to apply voltage across the variable resistance means (60); electrical measurement means (82) to provide a measurement means to measure change in voltage output of the variable resistance means (60) with movement of the potentiometer movement interconnection means (64);
f. an at least one stabilizer (40) having an at least one stabilizer frame (42); the at least one stabilizer frame (42) having a stabilizer frame first end (43) and a stabilizer frame second end (44); stabilizer pivot means (48) rotatably interconnecting the stabilizer frame first end (43) with a stabilizer pivot plate (46); stabilizer pivot means (48) rotatably interconnecting the stabilizer frame second end (44) with the extender frame (30) at the extender first side (37) or the extender second side (38);
g. stabilizer spring (52) means rigidly affixed to the at least one stabilizer (40) intermediate the stabilizer frame first end (43) and the stabilizer frame second end (44); the spring holder (50) extending from the at least one stabilizer (40) orthogonal to the frame axis (100); stabilizer spring (52) received by spring affixing means at the spring holder (50) and extending downwardly toward the frame bottom (16) when the extender component (20) is recessed;
h. a frame cover (90); an aperture in the frame cover (90) permitting passage of the extension component (20) for the extension and recession of the extension component (20); extension component (20) retainer (92) means interconnected with the frame cover (90) or frame.

6. A measuring device (1) from claim 5 further comprising:
a. the extender component (20) is proximal the frame bottom (16) when the extender component (20) is recessed; the extender component (20) pivotally extends upwardly from the frame bottom (16) when raised;
b. the Extender contact (32) proximal the Extender first end (35) extends a known and calibrated distance outwardly and beyond the Extender first end (35);
c. extender component (20) guide means receives an Extender guide rod (22), the Extender guide rod (22) is immovably fixed by guide rod immovable affixing means, proximal the Frame second end (14), at an Extender guide rod first locator (24); the Extender guide rod (22) is immovably fixed by guide rod immovable affixing means, distal the Frame second end (14), at an Extender guide rod second locator (26); the Extender pivot and attachment plate (28) is intermediate the Extender guide rod first locator (24) and the Extender guide rod second locator (26);
d. the stabilizer pivot plate (46) upstanding and rigidly affixed by plate affixing means to the frame bottom (16);
e. spring affixing means formed by a Spring holder (50); the spring holder comprised of a cylinder fixedly receiving the stabilizer spring (52) or other mechanical interconnections including clip, bracket and other spring attaching means rigidly affixed to the at least one stabilizer (40) intermediate the stabilizer frame first end (43) and the stabilizer frame second end (44); the spring holder (50) extending from the at least one stabilizer (40) orthogonal to the frame axis (100); stabilizer spring (52) received by spring affixing means at the spring holder (50) and extending downwardly toward the frame bottom (16) when the extender component (20) is recessed; the stabilizer spring (52) is compressed when the extender component (20) is recessed and urges the extender component (20) upwardly from the frame bottom (16); retraction means (70), having retraction means first end (72) and retraction means second end (74); the retraction means (70) affixed by retraction affixing means at the retraction means first end (72) to the extender pivot and attachment plate (28) and affixed by retraction affixing means at the retraction means second end (74) to a stabilizer pivot (46); the retraction means (70) urging by a spring function the extender component (20) upwardly and away from the frame bottom (16).

7. The Measuring device (1) of claim 6 further comprising:
a. the frame (10) and extender component (20) formed of rigid materials including metals, composite materials, plastics; the frame (10) being generally of planar materials; the extender component (20) being elongated and generally formed of extended tubular or planar rigid materials; the frame (10) and the extender component (20) being formed by processes including press, molded, machined or welded processes;
b. extender pivot (34) means comprised of aperture or bearing means fixedly and rotatably receiving a rod, bearing or bushing interconnecting the extender frame (30) proximal the extender frame first end (35) and the extender contact (32); the extender contact being generally ball shaped or cylindrical and extending outwardly and beyond the extender frame first end (35) for the purpose of contacting a frame or other NASCAR body component; the extender contact (32) extending beyond the extender frame first end (35) by a distance D1 (33);
c. the extender pivot and attachment plate (28) being generally planar and providing an anchor or affixing structure or plate to which is affixed the extender guide rod intermediate locator (25), retraction means (70) and potentiometer movement interconnection means (64);
d. the extender component (20) pivotally extends upwardly from the frame bottom (16) by the retraction means (70) provided by a spring (70) in tension when the extender component (20) is recessed; the spring (70) at the spring first end (72) affixed by spring affixing means at the extender pivot and attachment plate (28); spring affixing means including aperture receiving hook, eye hook with screw and other mechanical means; potentiometer movement interconnection means (64) includes aperture receiving rod with thread and bolt, eye hook with screw and other mechanical means;
e. the extender guide rod (22) being elongated and cylindrical provides stability in the movement of the extender component (20) when extended to measure a dimension of a frame or other component; the Extender guide rod (22) is immovably fixed by guide rod immovable affixing means, proximal the Frame second end (14), and distal to the frame second end (14) by mechanical means including bolt and nut, screw and welding provided by the extender guide rod first locator (24), which is proximal to or in contact with or extending from the frame second end (14), and the extender guide rod second locator (26) which is distal to the frame second end (14); the extender guide rod second locator (26) upstanding from the frame bottom (16) formed by press, molding, machining or other means and rigidly affixed to the frame bottom (16); aperture and bearing means (29) in the extender pivot and attachment plate (28) receives the extender guide rod (22); the aperture and bearing means (29) comprised of an aperture (29) in the extender pivot and attachment plate (28) or by extender guide rod intermediate locator (25) comprising a cylinder extending from the extender pivot and attachment plate (28) toward the frame first end (12) and having an aperture (29) therein which receives the extender guide rod (22); the extender guide rod (22) received substantially parallel with the frame axis (100);
f. the at least one stabilizer frame (42) is elongate and generally planar or cylindrical providing stabilizing support for the extender component (20) when the extender component (20) is extended; the at least one stabilizer frame (42) comprising at least two stabilizer frames (42) one each proximal the frame first side (17) and the frame second side (18) respectfully; stabilizer pivot means (48) comprised of aperture or bearing means fixedly and rotatably receiving a rod, bearing or bushing rotatably interconnecting the stabilizer frame first end (43) with a stabilizer pivot plate (46); the stabilizer pivot plate (46) upstanding and rigidly affixed by plate affixing means to the frame bottom (16); plate affixing means comprising machining, molding, forming, pressing, welding;
g. spring affixing means formed by a Spring holder (50) rigidly affixed to the at least one stabilizer (40) intermediate the stabilizer frame first end (43) and the stabilizer frame second end (44); the spring holder (50) extending from the at least one stabilizer (40) orthogonal to the frame axis (100); stabilizer spring (52) received by spring affixing means at the spring holder (50) and extending downwardly toward the frame bottom (16) when the extender component (20) is recessed; the stabilizer spring (52) is compressed when the extender component (20) is recessed and urges the extender component (20) upwardly from the frame bottom (16); retraction means (70), having retraction means first end (72) and retraction means second end (74); the retraction means (70) affixed by retraction affixing means at the retraction means first end (72) to the extender pivot and attachment plate (28) and affixed by retraction affixing means at the retraction means second end (74) to a stabilizer pivot (46); the retraction means (70) urging by a spring function the extender component (20) upwardly and away from the frame bottom (16);
h. the frame cover (90) generally parallel with the frame bottom (16); the retainer (92) movably interconnected with the frame cover (90); the retainer (92) extendable to obstruct or prevent extension of the extension component (20) and retractable to allow extension of the extension component (20); the retainer (92) slidably received by a bracket or slot means (94) proximal the frame first end (12), frame second end (14), frame first side (17) or frame second side (18).
